(19) United States
(12) Patent Application Publication
(10) Pub. No.: US 2011/0062857 A1
(43) Pub. Date: Mar. 17, 2011

(54) LIGHT EMITTING DIODE LIGHT SOURCE DEVICE WITH COLOR TEMPERATURE ADJUSTMENT CAPABILITY

(75) Inventors: CHUNG-MIN CHANG, Zhudong Township (TW); KUO-CHIANG CHEN, Hukou Township (TW); YU-CHENG LIN, Guishan Township (TW); MING-TAN YANG, Lunbei Township (TW); CHI-WEN GUO, Tainan City (TW); CHIA-HUNG HSU, Danshui Township (TW)

(73) Assignee: POWER LIGHT TECH. CO., LTD.

(21) Appl. No.: 12/879,104

(22) Filed: Sep. 10, 2010

(30) Foreign Application Priority Data
Sep. 11, 2009 (TW) 98130664

(51) Int. Cl. H01J 1/62

(52) U.S. Cl. 313/501

(57) ABSTRACT

An LED light source device with color temperature adjustment capability includes at least one light-emitting diode and a color temperature conversion element. A front end of the light-emitting diode has a light-emitting end. The color temperature conversion element is disposed in front of the light-emitting end of the light-emitting diode. The color temperature conversion element includes a light-transmitting substrate and color temperature conversion materials. The color temperature conversion materials are provided on/in the light-transmitting substrate. The color temperature conversion materials include high refractive index materials and low refractive index materials. The high refractive index materials that are selected from the group consisting of TiO₂, Ti₃O₅ or Ta₂O₅. The low refractive index materials that are selected from the group consisting of SiO₂ or MgF₂. The light beam emitted by the light-emitting diode passes through the color temperature conversion element to change its color temperature.

### BACKGROUND OF THE INVENTION

1. Field of the Invention

The present invention relates to a light-emitting diode (LED) light source device with color temperature adjustment capability, and in particular to a light-emitting diode light source device that is capable of adjusting its color temperature for specific illumination purposes.

2. Description of Related Art

The color temperature of common light sources such as sodium lamps, energy-saving bulbs, high-pressure mercury lamps or the like is in a range of 1500K to 7000K. With the advancement of technology and the raising in the consciousness of energy saving & carbon reduction, light-emitting diodes having high light-emitting efficiency and low electricity consumption are widely used as lightings.

The conventional light-emitting diode light source device utilizes white light-emitting diodes. The color temperature of the current white light-emitting diode is in a range of 2700K to 7000K. However, the lower color temperature white light-emitting diode performs poorly in light-emitting efficiency and in mass production. Thus, the white light-emitting diode is used as a higher color temperature light source. Although the light emitted by the high color temperature light source is brighter, it is not as soft as the light emitted by the lower color temperature light source. Thus, when an occasion with a special effect or atmosphere is needed, the lower color temperature light source is preferred. However, if the manufacturer intends to make a white light-emitting diode of a lower range of color temperature, the fluorescent powders used may cause a decrease in light-emitting efficiency and reliability, thereby reducing the yield, increasing the production cost, and limiting the application range in the white LED.

In order to overcome the above problems, the present Inventor proposes a novel and reasonable structure based on his delicate researches and expert experiences.

### SUMMARY OF THE INVENTION

The objective of the present invention is to provide a light-emitting diode light source device with color temperature adjustment capability. The light beam emitted by the LED passes through a color temperature conversion element to convert its original color temperature into a required value, thereby conforming to illumination requirements of a special color temperature.

In order to achieve the above objectives, the present invention provides a light-emitting diode light source device with color temperature adjustment capability. The lights source device includes: at least one light-emitting diode and a color temperature conversion element. A front end of the light-emitting diode has a light-emitting end. The color temperature conversion element is disposed in front of the light-emitting end of the light-emitting diode. The color temperature conversion element comprises a light-transmitting substrate and color temperature conversion materials. The color temperature conversion materials are provided on/in the light-transmitting substrate. The color temperature conversion materials comprise high refractive index materials and/or low refractive index materials. The high refractive index materials that are selected from the group consisting of TiO₂, Ti₃O₅ or Ta₂O₅. The low refractive index materials that are selected from the group consisting of SiO₂ or MgF₂.

The present invention further provides a light-emitting diode light source device with color temperature adjustment capability. The light source device includes: a lamp base; a lamp casing disposed at a front end of the lamp base, and a front end of the lamp casing having an opening; a lamp casing cover provided in the opening at the front end of the lamp casing, and the lamp casing cover having an light-exiting port; at least one light-emitting diode with its front end having a light-emitting end, and the light-emitting diode being disposed in the lamp casing with the light-emitting end facing toward the light-exiting port of the lamp casing cover; a circuit board provided inside the lamp base and electrically connected to the light-emitting diode; and a color temperature conversion element provided at the front end of the light-exiting port of the lamp casing cover, the color temperature conversion element comprising a light-transmitting substrate and color temperature conversion materials, the color temperature conversion materials being provided on/in the light-transmitting substrate, the color temperature conversion materials comprising high refractive index materials and/or low refractive index materials, the high refractive index materials selecting from the group consisting of TiO₂, Ti₃O₅ or Ta₂O₅, and the low refractive index materials selecting from the group consisting of SiO₂ or MgF₂.

According to the light-emitting diode light source device with color temperature adjustment capability of the present invention, the light-emitting diode emits a light beam toward the color temperature conversion element. After the light beam passes through the color temperature conversion element, the light beam is converted to have a specific color temperature, thereby conforming to the requirements for specific illumination. Especially, the white light-emitting diode of a high color temperature can be converted to have a low color temperature, so that the white light-emitting diode can be applied in a wider range.

Since the range of color temperature associated with the light-emitting diode light source device according to the present invention is wider, it can be used as a light source not only having a specific color temperature with high efficiency and reliability but also reducing the production cost greatly. Further, in addition to the white light-emitting diode, light-emitting diodes of any colors can generate a specific color temperature by applying the color temperature conversion element according to the present technique. As a result, the inherent color and color temperature of the light-emitting diode are not required to be changed, so that the consistency of the light-emitting diode can be enhanced.

In order to further understand the characteristics and technical contents of the present invention, a description relating thereto will be made with reference to the accompanying drawings. However, the drawings are illustrative only but not used to limit the present invention.

### BRIEF DESCRIPTION OF THE DRAWINGS

FIG. 1 is a schematic view showing the light-emitting diode light source device with color temperature adjustment capacity according to a first embodiment of the present invention;

FIG. 2 is a schematic view showing the light-emitting diode light source device with color temperature adjustment capacity according to a second embodiment of the present invention;

FIG. 3 is a schematic view showing the color temperature conversion element of the light-emitting diode light source device with color temperature adjustment capacity according to the present invention;

FIG. 4 is a spectrum view of the first group of the light source device;

FIG. 5 is a view showing the CIE color coordinates of the first group of the light source device;

FIG. 6 is a spectrum view of the second group of the light source device;

FIG. 7 is a view showing the CIE color coordinates of the second group of the light source device;

FIG. 8 is a spectrum view of the third group of the light source device;

FIG. 9 is a view showing the CIE color coordinates of the third group of the light source device; and

FIG. 10 is a schematic view showing the light-emitting diode light source device with color temperature adjustment capacity according to a third embodiment of the present invention.

### DETAILED DESCRIPTION OF THE PREFERRED EMBODIMENTS

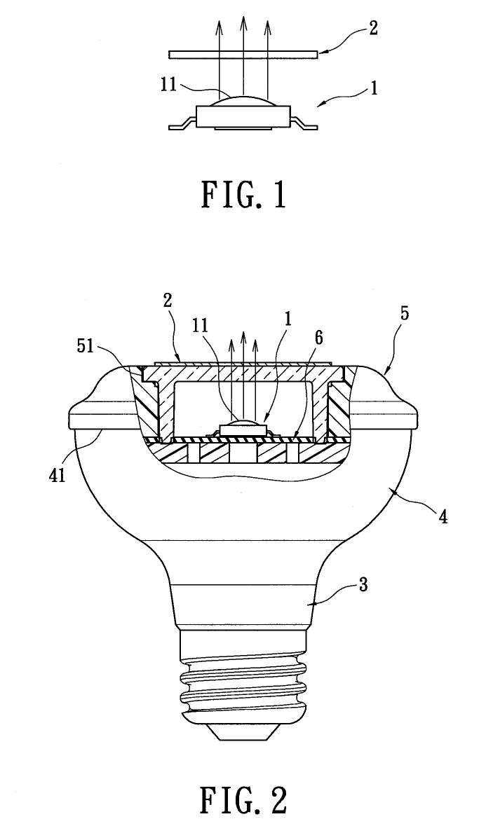

Please refer to a first embodiment shown in FIG. 1. The present invention provides a light-emitting diode light source device with color temperature adjustment capability. The light source device includes at least one light-emitting diode 1 and a color temperature conversion element 2. The front end of the light-emitting diode 1 has a light-emitting end 11. The color temperature conversion element 2 is disposed in front of the light-emitting end 11 of the light-emitting diode 1. A light beam emitted by the light-emitting diode 1 passes through the color temperature conversion element 2 and changes its color temperature.

Please refer to a second embodiment shown in FIG. 2. The present invention provides a light-emitting diode light source device with color temperature adjustment capability. The light source device includes a lamp base 3, a lamp casing 4, a lamp casing cover 5, at least one light-emitting diode 1, a circuit board 6, and a color temperature conversion element 2. The lamp casing 4 is disposed at the front end of the lamp base 3. The lamp casing 4 is a hollow structure and has an opening 41 at its front end. The lamp casing cover 5 covers the opening 41 at the front end of the lamp casing 4. The lamp casing cover 5 has a light-exiting port 51 penetrating therebetween. The front end of the light-emitting diode 1 has a light-emitting end 11. The light-emitting diode 1 is provided in the interior of the lamp casing 4 with the light-emitting end 11 facing toward the light-exiting port 51 of the lamp casing cover 5. The circuit board 6 is electrically connected to the light-emitting diode 1. The color temperature conversion element 2 is disposed at the front end of the light-exiting port 51 of the lamp casing cover 5. The color temperature conversion element 2 can be disposed in other positions by any methods, and it can be fixed to the front end of the light-exiting port 51 of the lamp casing cover 5 detachably or by any suitable means. A light beam emitted by the light-emitting diode 1 passes through the color temperature conversion element 2 at the front end of the light-exiting port 5 to change its color temperature.

In the light-emitting diode light source device with color temperature adjustment capability according to the present invention, the light-emitting diode 1 is a white light-emitting diode that is suitable for illumination. The blue LED chip is covered by yellow fluorescent powders, the red LED chip is covered by cyan fluorescent powders, the green LED chip is covered by purple (magenta) fluorescent powders or the amber LED chip is covered by royal blue to form a white light-emitting diode. The light-emitting diode 1 can be made by adding at least two or more than two fluorescent powders in the encapsulant of at least one (one or more than one) of the red, amber, green, blue, purple light-emitting diodes.

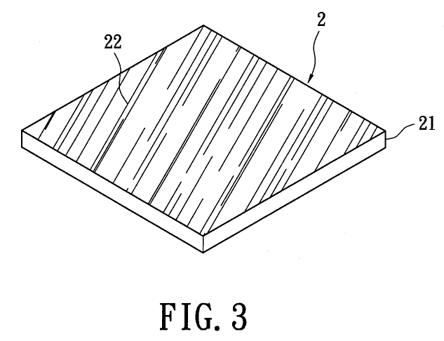

Please refer to FIG. 3. The color temperature conversion element 2 comprises a light-transmitting substrate 21 and color temperature conversion materials 22 that combine to form a color temperature conversion layer. The color temperature conversion materials 22 are provided on or in the light-transmitting substrate 21. As shown in FIG. 3, the color temperature conversion materials 22 can be vapor-deposited onto the surface of the light-transmitting substrate 21 to form a thin film. The materials of the light-transmitting substrate 21 may be glass, plastics, resin, rubber, silicon or other macromolecular polymers.

Similarly, the color temperature conversion material 22 can be vapor-deposited on a lens, a lamp cover, a reflecting mirror or a plastic film to form the color temperature conversion element 2. In other words, the color temperature conversion element 2 is the lens, the lamp cover, the refractive cover, and the plastic mirror whose surface is vapor-deposited with a film of the color temperature conversion material 22.

The color temperature conversion materials 22 comprise high refractive index materials and/or low refractive index materials. The high refractive index materials are selected from the group consisting of TiO₂, Ti₃O₅ or Ta₂O₅, and the low refractive index materials are selected from the group consisting of SiO₂ or MgF₂. Further, a middle refractive index material, such as Al₂O₃ or ZrO₂, can be added on demands.

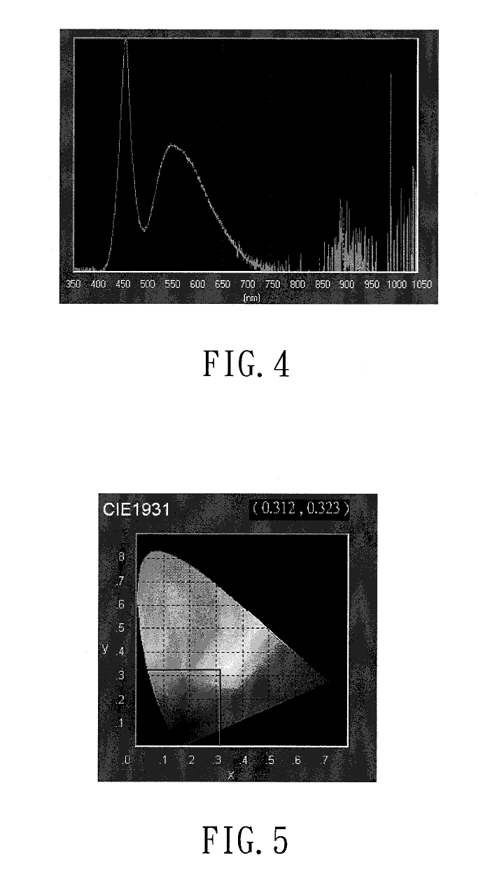

After the light beam emitted by the light-emitting diode 1 passes through the color temperature conversion element 2, the light beam having a low color temperature and a specific spectrum is generated and transmitted out of the light source device. The following experimental results show the effects achieved by the light-emitting diode light source device with color temperature adjustment capability according to the present invention. Please refer to FIGS. 4 to 9. Three groups of light source devices use the same white light-emitting diodes. The CIE color coordinates and the color temperatures of these three groups of light source devices are listed in the following table:

| | Light source | CIE color | Color |
|---|---|---|---|
| group | device | coordinate | temperature |
| The first group | White light- | (0.312, 0.323) | 6592 K |
| | emitting diode | | |
| The second group | White light- | (0.428, 0.500) | 3739 K |
| | emitting diode + | | |
| | color temperature | | |
| | conversion | | |
| | element A | | |
| The third group | White light- | (0.597, 0.388) | 1723 K |
| | emitting diode + | | |
| | color temperature | | |
| | conversion | | |
| | element B | | |

The first group of light source device is a white light-emitting diode. FIG. 4 is a diagram showing the spectrum of light emitted by the first group of the light source device, and FIG. 5 is a diagram showing the CIE color coordinates of the light emitted by the first group of the light source device. The CIE color coordinate is offset to (0.312, 0.323). The color temperature is 6592K.

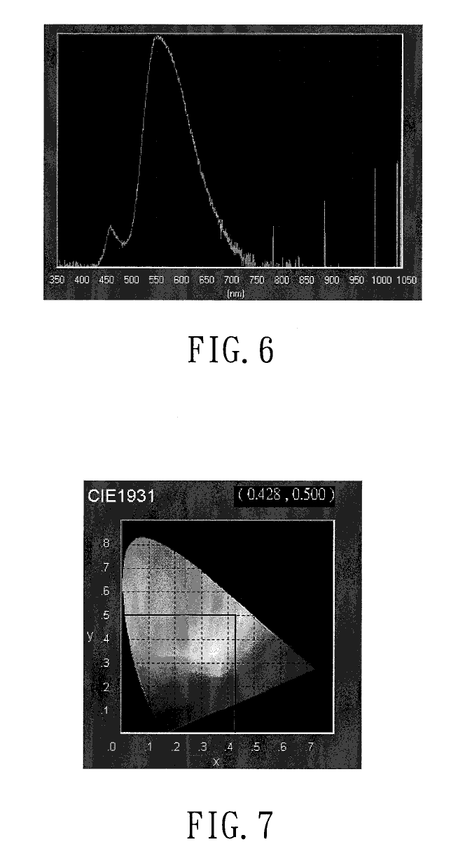

The second group of light source device is a white light-emitting diode plus a color temperature conversion element A. FIG. 6 is a diagram showing the spectrum of light emitted by the second group of the light source device, and FIG. 7 is a diagram showing the CIE color coordinates of the light emitted by the second group of the light source device. The CIE color coordinate is offset to (0.428, 0.500). The color temperature is reduced from 6592K to 3739K.

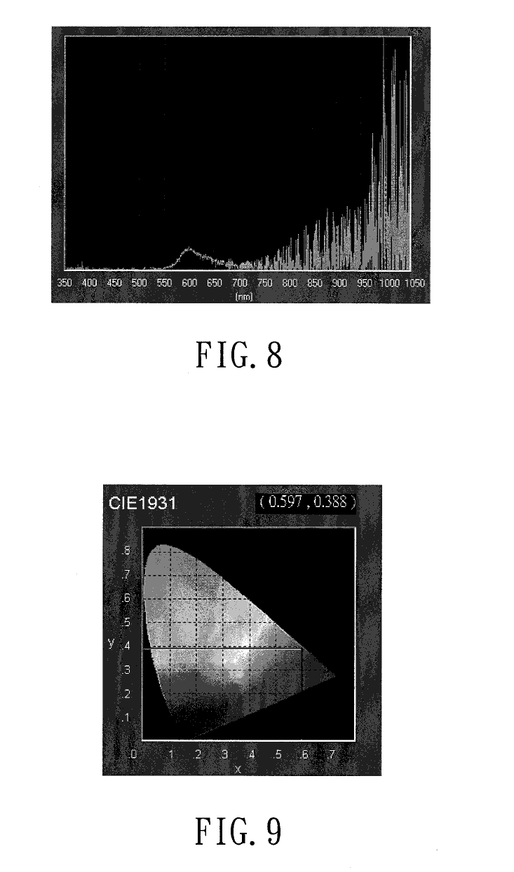

The third group of light source device is a white light-emitting diode plus another color temperature conversion element B. FIG. 8 is a diagram showing the spectrum of light emitted by the third group of the light source device, and FIG. 9 is a diagram showing the CIE color coordinates of the light emitted by the third group of the light source device. The CIE color coordinate is offset to (0.597, 0.388). The color temperature is reduced from 6592K to 1723K.

According to the above experimental results, the present invention can reduce the color temperature of the light emitted by the white light-emitting diode, so that the white light-emitting diode can be applied to a streetlamp, a spotlight or other light source devices. Thus, in addition to illumination, soft light can be emitted to generate decorative and special effects.

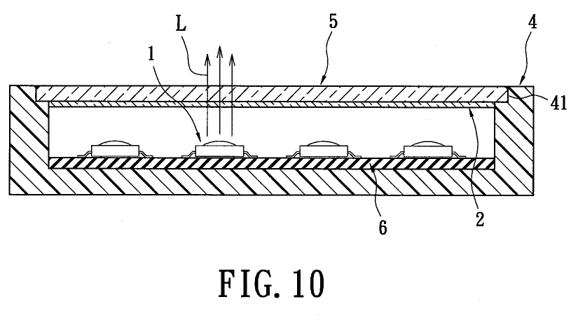

Furthermore, referring to FIG. 10, the third embodiment of the present invention provides a light-emitting diode light source device with color temperature adjustment capability. The light source device includes at least one light-emitting diode 1, a color temperature conversion element 2, a lamp casing 4, a lamp casing cover 5 and a circuit board 6. The lamp casing 4 has an opening 41 formed on a top side thereof. The lamp casing cover 5 is disposed on the lamp casing 4 for covering the opening 41 of the lamp casing 4. The color temperature conversion element 2 may be disposed or formed (such as coating, printing, spraying etc.) on a bottom surface of the lamp casing cover 5, and the color temperature conversion element 2 includes a light-transmitting substrate 21 and a color temperature conversion layer 22, thus the color temperature conversion element 2 may be a multilayer. The color temperature conversion layer 22 is formed on or in the light-transmitting substrate 21 and the color temperature conversion layer 22 has a first material and/or a second material. The refraction index of the first material is larger than the refraction index of the second material, the first material is selected from the group consisting of TiO₂, Ti₃O₅ or Ta₂O₅, and the second material is selected from the group consisting of SiO₂ or MgF₂. The circuit board 6 is disposed in the lamp casing 4. The at least one light-emitting diode 1 is disposed in the lamp casing 4 and electrically connected to the circuit board 6, and light beams L generated by the at least one light-emitting diode 1 pass through the color temperature conversion element 2 and lamp casing cover 5 in sequence. Further, for the consideration of cost down and light extraction efficiency enhancement, the color temperature conversion layer 22 is directly formed onto the bottom surface of the lamp casing cover 5 without using the light-transmitting substrate 21, and then the lamp casing cover 5 with the color temperature conversion layer 22 is disposed on the lamp casing 4 for covering the opening 41 of the lamp casing 4.

According to the light-emitting diode light source device with color temperature adjustment capability, after the light beam emitted by the white light-emitting diode passes through the color temperature conversion element 2, a light beam having a low color temperature and a specific spectrum can be obtained, thereby forming a light source of a low color temperature satisfying the demands for illumination or decoration. Further, it is unnecessary to use fluorescent powders which cause a decrease in light-emitting efficiency and reliability in order to achieve a specific color temperature, so that the color temperature and quality can be balanced, and the production cost can be reduced greatly.

In addition to the white light-emitting diode, the present invention can be applied to the light-emitting diodes 1 of other colors. The light source device using light-emitting diode 1 of various colors can achieve a specific demand with the color temperature conversion element 2 increasing or decreasing the color temperature of the light beam emitted by the light-emitting diode 1. As a result, the inherent color and the color temperature of the light-emitting diode are not required to be changed, so that the consistency of the light-emitting diode 1 can be enhanced.

Further, according to the present invention, by selecting the color temperature conversion element 2 of different color temperature conversion materials 22, the color temperature adjustment can be achieved. Thus, the color temperature can be reduced or increased on demands

The above-mentioned descriptions represent merely the preferred embodiments of the present invention, without any intention to limit the scope of the present invention thereto. Various equivalent changes, alternations or modifications based on the claims of present invention are all consequently viewed as being embraced by the scope of the present invention.

What is claimed is:

1. A light-emitting diode light source device with color temperature adjustment capability, comprising:
at least one light-emitting diode having a light-emitting end formed on a front thereof; and
a color temperature conversion element disposed in front of the light-emitting end of the at least one light-emitting diode, and the color temperature conversion element comprising a color temperature conversion layer.

2. The light-emitting diode light source device according to claim 1, wherein the color temperature conversion element comprises a light-transmitting substrate, the color temperature conversion layer is formed on or in the light-transmitting substrate, the color temperature conversion layer has a first material and/or a second material, the refraction index of the first material is larger than the refraction index of the second material, the first material is selected from the group consisting of TiO₂, Ti₃O₅ or Ta₂O₅, the second material is selected from the group consisting of SiO₂ or MgF₂.

3. The light-emitting diode light source device according to claim 2, wherein the color temperature conversion layer further comprises a middle refractive index material that is selected from the group consisting of Al₂O₃ or ZrO₂.

4. The light-emitting diode light source device according to claim 1, wherein the at least one light-emitting diode is a white light-emitting diode.

5. The light-emitting diode light source device according to claim 1, wherein the color temperature conversion layer is vapor-deposited onto a surface of the light-transmitting substrate to form a thin film.

6. The light-emitting diode light source device according to claim 1, wherein the light-transmitting substrate is made of macromolecular polymers.

7. The light-emitting diode light source device according to claim 6, wherein the macromolecular polymers comprises glass, plastic, resin, rubber or silicon.

8. A light-emitting diode light source device with color temperature adjustment capability, including:
a lamp casing having an opening formed on a top side thereof;
a lamp casing cover disposed on the lamp casing for covering the opening of the lamp casing;
a color temperature conversion element disposed on a bottom surface of the lamp casing cover, wherein the color temperature conversion element comprises a color temperature conversion layer;
a circuit board disposed in the lamp casing; and
at least one light-emitting diode disposed in the lamp casing and electrically connected to the circuit board, wherein light beams generated by the at least one light-emitting diode pass through the color temperature conversion element and lamp casing cover in sequence.

9. The light-emitting diode light source device according to claim 8, wherein the color temperature conversion element comprises a light-transmitting substrate, the color temperature conversion layer is formed on or in the light-transmitting substrate, the color temperature conversion layer has a first material and/or a second material, the refraction index of the first material is larger than the refraction index of the second material, the first material is selected from the group consisting of TiO₂, Ti₃O₅ or Ta₂O₅, the second material is selected from the group consisting of SiO₂ or MgF₂.

10. The light-emitting diode light source device according to claim 9, wherein the color temperature conversion layer further comprises a middle refractive index material that is selected from the group consisting of Al₂O₃ or ZrO₂.

11. The light-emitting diode light source device according to claim 8, wherein the at least one light-emitting diode is a white light-emitting diode.

12. The light-emitting diode light source device according to claim 8, wherein the color temperature conversion layer is vapor-deposited onto a surface of the light-transmitting substrate to form a thin film.

13. The light-emitting diode light source device according to claim 8, wherein the light-transmitting substrate is made of macromolecular polymers.

14. The light-emitting diode light source device according to claim 13, wherein the macromolecular polymers comprises glass, plastic, resin, rubber or silicon.
